(19) United States
(12) Patent Application Publication
(10) Pub. No.: US 2023/0376740 A1
(43) Pub. Date: Nov. 23, 2023

(54) MULTICOLOR TUNABLE RESERVOIR COMPUTING METHOD AND SYSTEM

(71) Applicant: HUAWEI TECHNOLOGIES CANADA CO., LTD., Kanata (CA)

(72) Inventors: Behrooz SEMNANI, Kanata (CA); Armaghan ESHAGHI, Kanata (CA)

(73) Assignee: HUAWEI TECHNOLOGIES CANADA CO., LTD., Kanata (CA)

(21) Appl. No.: 18/222,205

(22) Filed: Jul. 14, 2023

Related U.S. Application Data
(63) Continuation of application No. PCT/CA21/50077, filed on Jan. 25, 2021.

(51) Int. Cl. G06N 3/067

(52) U.S. Cl. CPC G06N 3/0675

(57) ABSTRACT

A method for operating a reservoir computer includes receiving an input symbol and applying a time mask to the input symbol to produce a plurality of time multiplexed nodes. The method includes modulating, using the plurality of time nodes, a plurality of frequency channels to produce a plurality of frequency nodes and multiplexing the plurality of frequency nodes to produce a plurality of multiplexed frequency nodes. The method also includes coupling the multiplexed frequency nodes into a reservoir that includes a non-linear element and receiving a delayed plurality of time-frequency multiplexed nodes from the reservoir. The method also includes demultiplexing the delayed plurality of multiplexed frequency nodes to produce a plurality of delayed time nodes and modulating, using the plurality of delayed time nodes and the input time nodes, the plurality of frequency channels. The method further includes outputting a response based on the plurality of delayed time nodes.

### FIELD OF THE INVENTION

The present invention pertains to the field of real-time computing machines, and in particular to a method and apparatus for multicolor tunable reservoir computers.

### BACKGROUND

Reservoir computing (RC) is a bioinspired computational paradigm that employs fixed chaotic dynamical systems to increase the dimensionality of sequential data. This boosts the adoption of a secondary stage in a computing arrangement to extract and classify the information without the need for complex nonlinear computing platforms. RCs can open up tantalizing possibilities in real-time computing machines, significantly enhancing the computational power of real-time information processing machines and pave the way towards improved performance in data communications. Some RCs may be implemented using photonic technology that can be potentially imprinted on semiconductor ICs. Photonic RCs may take advantage of delay-feedback architectures which heavily rely on optoelectronic modulators as well as ultrafast detection schemes.

A delay line together with a nonlinear node constitutes an elementary topology of a delay-feedback reservoir. The complex dynamics of the reservoir are engaged by time multiplexing to create virtual nodes over the delay line. The delay time is usually harmonized to the sequence of input data. To create a sufficiently strong nonlinear mapping, the independent internal states of the reservoir are increased by time multiplexing at a rate much fast than the delay time of the delay line. The number of virtual nodes created by time multiplexing may thus be limited by the speed of input data modulation using time masking techniques. Time masking is a procedure where raw input data is transformed into a piece-wise constant function. A repeating pattern, the “mask”, is multiplied on top of the input data. The resulting masked signal is input into the system to evoke a more complex phase space response. In applications, hundreds of nodes are normally needed, which in turn requires an input time for multiplexing that is hundreds of times faster than the sequence of input data. Moreover, at the readout stage, the detectors must be able to resolve the time nodes and therefore detectors must be sufficiently fast to keep up with the speed of multiplexing.

Many RC platforms take advantage of chaotic optical or optoelectronic systems that can operate at the boundary of instability. Among those, the delay feedback architectures are able to meet the requirements of an efficient RC system. A delay feedback RC combines a feedback loop with a time delay comparable to the input symbol duration and a single nonlinear node to perform high-dimensional mapping. A number of virtual nodes are created by time modulation (time masking) with a rate normally hundreds of times faster than the input bit or symbol duration. To map an input stream of sequential data into higher dimensions, the reservoir can be configured to have recurrent connections of the independent nodes which are already created in time domain. In many implementations of delay-feedback structures, a fast time-multiplexing mask for each symbol is used at the input. The faster the multiplexing, the higher the number of virtual nodes that will be created. For complicated tasks such as speech recognition or nonlinear channel equalization, a sufficient number of nodes created by a fast time multiplexing mask can be required to nonlinearly increase the dimensionality of the input data and render it linearly separable. However, fast multiplexing may be limited by electrical bottlenecks which hinders the adoption of RCs for high speed data communications and fast real-time information processing.

Operating a reservoir computer commonly involves multiple steps including adding the current input to the internal states, linearly connecting the internal states, carrying out a nonlinear operation on the internal states, multiplying and adding the internal states by output weights. State-of-the-art electronic technology is often limited to a detection speed at the readout stage of less than 50 GHz. Often, more than one hundred virtual nodes are required so the reservoir can perform sufficiently strong high-dimensional mapping. The maximum symbol rate that can be tolerated by a delay-feedback RC is thus limited by approximately 0.5 GHz by electrical bottlenecks. Although alternative all-optical platforms can in-principle go beyond this limit by employing all-optical modulation schemes, their integration on-chip still remains an outstanding challenge.

Some IC based RC designs attempt to eliminate the need for fast time modulations but still have disadvantages. The connectivity of nodes is static and strictly depends on the topology of the chip. For complicated tasks, a huge number of nodes are needed which in turn leads to a relatively big chip size as well as bulky detector arrays.

Other frequency-multiplexed RCs based on the use of a delay loop have been proposed. The reservoir states are encoded in the amplitude and phase of the frequency sidebands of a highly coherent laser propagating in a single-mode, polarization-maintaining fiber optical loop. Since the reservoir nodes are created in the frequency domain, a single nonlinear node which is implemented by a phase modulator can couple the frequency nodes and an echo state network can be created due to the recurrent nature of the dynamics. This method is however limited by the number of frequency nodes created by the phase modulator which limits the performance of the resultant RC.

While delay feedback platforms are proven to demonstrate excellent performance as RCs at the edge of instability, experimental reservoir computers based on time-domain multiplexing suffer from an inherent trade-off between the number of neurons (or virtual nodes) and the processing time. To maintain the computational power of a reservoir, usually more than hundreds of time nodes are required which implies very fast multiplexing of the input data sequence. Specifically, for higher bit rates, known modulators cannot create a sufficient number of time nodes by multiplexing due to electrical bottlenecks.

Therefore, there is a need for a method and apparatus for an RC that obviates or mitigates one or more limitations of the prior art. For example, by improving the computational power of a reservoir while reducing the need for very fast time multiplexing masks.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide an apparatus and method for a photonic reservoir computer (RC) that utilizes both time and frequency multiplexing to achieve high computational power without the need for high speed electronics for time multiplexing or readout. The use of both time and frequency multiplexing allows for the creation of sufficient nodes without being constrained by electrical or electronic bottlenecks. Embodiments include frequency parallelization methods which eliminate the need for very fast time multiplexing and add an additional degree of freedom to the system which can enrich the dynamics and enhance the computational power of the resultant RC.

In accordance with embodiments of the present invention, there is provided a method for operating a reservoir computer. The method includes receiving an input symbol and applying a time mask to the input symbol to produce a plurality of time multiplexed time nodes. The method further includes modulating, using the plurality of time nodes, a plurality of frequency channels to produce a plurality of frequency nodes and multiplexing the plurality of frequency nodes to produce a plurality of multiplexed frequency nodes. The method further includes coupling the multiplexed frequency nodes into a reservoir where the reservoir includes a non-linear element. The method further includes receiving a delayed plurality of multiplexed frequency nodes from the reservoir, demultiplexing the delayed plurality of multiplexed frequency nodes to produce a plurality of delayed time nodes, modulating, using the plurality of delayed time nodes and input time nodes, the plurality of frequency channels, and outputting a response where the response is based on the plurality of delayed time nodes.

This provides the technical benefit of having both time nodes and frequency nodes that are processed in parallel, thus reducing the required processing speed of electronic components in the RC.

In further embodiments, the plurality of frequency channels are modulated after being multiplexed to form the plurality of multiplexed frequency nodes.

This provides the technical benefit of being able to use optical components such as microring resonators to modulate the multiplexed frequency nodes.

In further embodiments, the plurality of frequency channels are modulated before being multiplexed to form the plurality of multiplexed frequency nodes.

This provides the technical benefit of being able to use modulators such as electro-absorption modulators (EAMs) or Mach-Zehnder modulators (MZMs) to modulate the multiplexed frequency nodes.

In further embodiments, the plurality of delayed time nodes are input to a coupling network, wherein the coupling network outputs a plurality of modulator driving signals.

This provides the technical benefit of providing a feedback loop and implementing coupling between nodes of different frequencies.

In further embodiments, the plurality of modulator driving signals are outputs of electronic circuits. In other embodiments, the plurality of modulator driving signals are outputs of optical circuits.

This provides the technical benefit of allowing flexibility in the design of the circuits producing modulator driving signals.

Further embodiments include a modulator profile compensator to receive the plurality of delayed time nodes, the output of the modulator profile compensator being provided as input to the coupling network.

In further embodiments, the demultiplexing module, for example a frequency demultiplexing module, and the coupling network are combined in an optical circuit.

This provides the technical benefit of avoiding extra stages of optical to electrical or electrical to optical signal conversions.

In further embodiments, the plurality of modulator driving signals are based on the plurality of delayed time nodes and a masked data input, and the masked data input is an input to the coupling network.

In accordance with embodiments of the present invention, there is provided a reservoir computer (RC) including a frequency multiplexer portion receiving a plurality of virtual nodes of an input symbol. The frequency multiplexer portion outputs a modulated wavelength division multiplexing signal including the plurality of virtual nodes. The plurality of virtual nodes includes a plurality of time nodes and a plurality of frequency nodes. The

RC includes a modulator portion coupled to the frequency multiplexer portion for modulating the plurality of virtual nodes to produce a plurality of modulated frequency nodes and a delay line coupled to the frequency multiplexer portion and the modulator portion. The delay line receives the plurality of modulated frequency nodes and produces a plurality of delayed frequency nodes. The RC also includes a demultiplexer portion receiving the plurality of delayed frequency nodes and producing a plurality of coupling matrix inputs. Each of the plurality of inputs are derived from a demultiplexed one of the plurality of delayed frequency nodes. The RC includes a coupling network coupled to the demultiplexer portion and the modulator portion. The coupling network receives the coupling matrix inputs and produces a plurality of modulator driving signals.

This provides the technical benefit of an RC having both time nodes and frequency nodes that are processed in parallel, thus reducing the required processing speed of electronic components in the RC.

In further embodiments, the plurality of virtual nodes is modulated after being multiplexed to form the modulated wavelength division multiplexing signal. In other embodiments, the plurality of virtual nodes is modulated before being multiplexed to form the modulated wavelength division multiplexing signal.

This provides the technical benefit of supporting a variety of modulating devices including microring resonators, EAMs, or MZMs.

In further embodiments, the plurality of modulator driving signals are outputs of electronic circuits. In other embodiments, the plurality of modulator driving signals are outputs of optical circuits.

This provides the technical benefit of allowing flexibility in the design of the circuits producing modulator driving signals.

Further embodiments include a modulator profile compensator to receive the plurality of delayed frequency nodes where the outputs of the modulator profile compensator are provided as inputs to the coupling network.

This provides the technical benefit of providing the ability to remove any baseline associated with imperfect modulation profiles.

In further embodiments, the modulator profile compensator and the coupling network are combined in an optical circuit.

This provides the technical benefit of avoiding extra stages of optical to electrical or optical to electrical signal conversions.

In further embodiments, the delay line includes a non-linear element.

Further embodiments include an output stage outputting a response based on the delayed plurality of delayed frequency nodes.

In further embodiments, the coupling network further receives a masked data input and the plurality of modulator driving signals are based on both the coupling matrix inputs and the masked data input.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates a reservoir computer (RC) according to an embodiment.

FIG. 2 illustrates a set of time nodes and frequency nodes with coupling between nodes, according to an embodiment.

FIG. 3 illustrates an input symbol being time masked into time nodes and then into frequency nodes, according to an embodiment.

FIG. 4 illustrates a merged demultiplexing module and coupling network, according to an embodiment.

FIG. 5 illustrates a detailed view of a portion of a merged demultiplexing module and coupling network, according to an embodiment.

FIG. 6 illustrates an RC that utilizes EAMs to modulate frequency nodes, according to an embodiment.

FIG. 7 illustrates an embodiment of an RC utilizing Mach-Zehnder modulators to modulate frequency nodes, according to an embodiment.

FIG. 8 illustrates an embodiment of an RC including steps taken when operating the RC, according to an embodiment.

It will be noted that throughout the appended drawings, like features are identified by like reference numerals.

### DETAILED DESCRIPTION

Embodiments of the present invention relate to photonic reservoir computers (RCs) that utilize both time and frequency multiplexing to achieve high computational power without the need for high speed electronics for time multiplexing or readout. The use of both time and frequency multiplexing allows for the creation of sufficient nodes without being constrained by electrical bottlenecks. Embodiments include frequency parallelization methods which eliminate the need for very fast time multiplexing and add an additional degree of freedom to the system which can enrich the dynamics and enhance the computational power of the resultant RC.

To reduce the required multiplexing speed and at the same time maintain a sufficient number of virtual nodes (each node may be identified by its time and frequency) created in the reservoir. Embodiments use multiple frequency channels that are coupled through a tunable coupling network. The number of nodes, that are originally created by a time mask are dependent on time, can be increased and the nonlinear dynamics can be enriched which leads to a higher performing reservoir.

Embodiments multiplex nodes at multiple frequencies in the delay feedback channel. The frequency channels are fed externally, and each channel may have its own modulator. Phase modulators are not required, and the frequency nodes are coupled through a tunable network. The RC may have external controls for adjusting the dynamics of the reservoir. Optimized performance of the RC can require adjusting the platform for the best configuration of the coupling network.

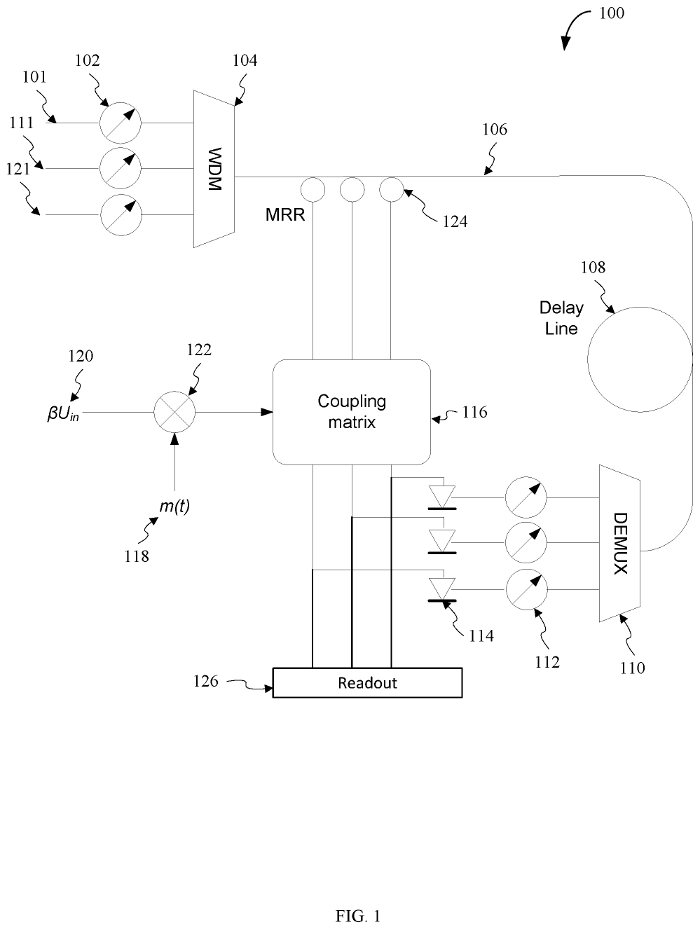

FIG. 1 illustrates a reservoir computer (RC) according to an embodiment. Though only three frequency channels are illustrated, an arbitrary number of frequency channels can be utilized. A plurality of time nodes, which are time-masked versions of an input symbol sequence is injected into the reservoir through electronic circuitry. With time-masking, also known as time-multiplexing, the input time symbols are transformed into piece-wise constant functions. A repeating pattern, referred to as a “mask”, is multiplied on top of each input symbol. The resulting masked signal, referred to as “time nodes”, may then be input to an RC to evoke a more complex phase space response. In this embodiment, each time node is used to produce three nodes 101, 111, and 121, based on optical wavelength (λ) or frequency (f), where λ=1/f. This may be done by converting the time node from an electrical signal to an optical signal and using a splitter or by dividing the time node in the electrical domain and then converting each copy of the time node into an optical signal. Each of the nodes 101, 111, and 121 as illustrated in FIG. 1 are constant laser optical signals that are then passed through tunable attenuators 102 set to frequencies matching wavelength division multiplexer (WDM) filter 104. Attenuators (102) adjusted to set the loop gain that is fixed for each computational task. For each computational task performed by the RC, the attenuators 102 settings or the attenuators themselves may be changed. The outputs of the tunable attenuators 102 are constant laser optical signals. The attenuator 102 outputs are then combined in WDM 104, to produce frequency multiplexed time nodes, with the combined signal launched on to fiber 106. The combined optical signal is modulated by microring resonators 124. A microring resonator is a type of optical ring resonator which includes a set of optical waveguides. Light entering the microring resonator may be passed or blocked depending on its frequency and controlled to act as a modulator. Fiber 106 may be coiled to produce delay line 108 before entering demultiplexer (DEMUX) 110. Fiber 106 and delay line 108 have a propagation delay and act as a delay feedback line. DEMUX 110 splits the combined optical signal into the three nodes, each at their own frequencies. Filters 112 are used to attenuate light outside of the frequency bands of filters 112. Optical to electrical (O/E) converters 114 convert the received optical signals into electric signals which may be received or monitored at readout 126. Readout 126 is an electrical signal which contains the information of the time multiplexed nodes in series. The signal will be sampled in time to demultiplex the time nodes. The received electrical signals are also used as inputs to coupling matrix 116, which is used to drive modulators 124. The coupling matrix receives the delayed time nodes from DEMUX 110 as well as the time multiplexed input data stream, inputs βUᵢₙ 120 and mask, m(t) 118, to produce the plurality of modulator driving signals to drive modulators 124. . Input 120 is the sequence of input data to the RC, multiplexed in time by mask, m(t) 118. Coupling matrix 116 provides the function of coupling the output of delay line 108 with time multiplexed input of input 120 multiplexed by mask 118.

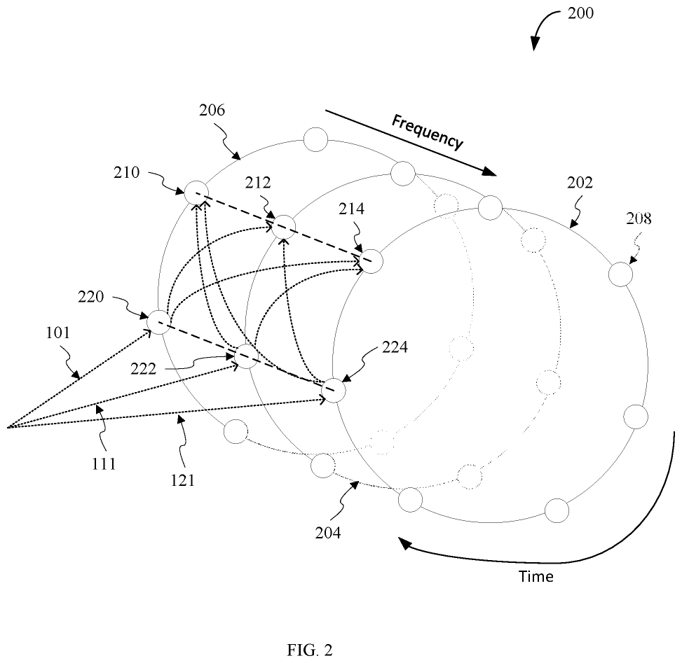

FIG. 2 schematically displays an equivalent network of virtual nodes associated with the RC platform shown in FIG. 1. Without loss of generality, three frequency channels (rings) 202, 204, and 206 are illustrated though any number of frequency channels may be used. The three frequency loops 202, 204, and 206 represent the feedback channels created for each frequency which are selected by tunable attenuators 102. The number of time nodes, such as 208, of frequency channels, such as 202, are determined by the speed at which the input time multiplexing is performed compared to the data rate of the input data. For example, if the input data contains one sample per 100 ns and the time multiplexing is ten times faster, then there would be ten time nodes for in each wavelength (ring) 202. The nonlinear node here is an Ikeda type nonlinearity described by a sinusoidal function F(ζ), though a nonlinear node may also be realized by other types of nonlinear functions, such as a Gaussian function used to model a ring modulator. The coupling matrix 126, C, compactly describes how the delayed signal running at different frequency channels excites the modulators 124 driving the other channels. For example, if C₁₂=0.5, then the modulator at the first frequency channel will be excited by the delayed signal propagated by the second channel by the factor of 0.5 (cross-loop gain).

Data input 101, 111, and 121 are input to nodes 220, 222, and 224, respectively. The input multiplexed signal in fiber 106 is coupled to the channels through the column matrix β̅. Since the RC is intended to utilize a fewer number of nodes, the dispersion of the delay line may be ignored, and it can be assumed that all colors experience identical delays (which is denoted by T_{d}). There is usually a slow process involved in the modulation step (nonlinear node) which can be crudely approximated by a single-pole low-pass filter with the time scale τ. If the state of the network is denoted by the tensor X̅=[Xᵢⱼ] where i and j are the index of time and frequency nodes respectively. Therefore, the dynamical equation can be defined as follows:

τ\overline{\dot{X}}+X̅=η\hat{F}[β̅Xᵢₙ(t)+αCX̅(t−T_{d})]

Where the nonlinear function F[·] can be determined by the following:

$$F ( ζ ) = sin ( \frac{π}{2} \frac{ζ + {V}_{d c}}{{V}_{π}} )$$

Where V_{π}is the voltage required to achieve a full modulation depth of a modulator, such as a Mach-Zehnder modulators. The above nonlinear differential equation describes recurrent dynamics which can effectively span different types of nonlinear regimes from monostable and bistable behavior to deterministic chaos. The nonlinear dynamics can be adjusted by varying the loop parameters namely loop gains, α, modulators' DC bias V_{dc} as well as input gain vector β. The RC can usually be adjusted to operate at the edge of instability and may be adjusted to achieve optimal performance.

Embodiments differ from prior RCs in the tensor nature of the state vector X. The nonlinear node, i.e., the modulators 124 together with the coupling network 116, couple the different frequency channels and the resultant nonlinear dynamics are enriched with respect to a delay system with an equal number of time nodes with a single frequency channel.

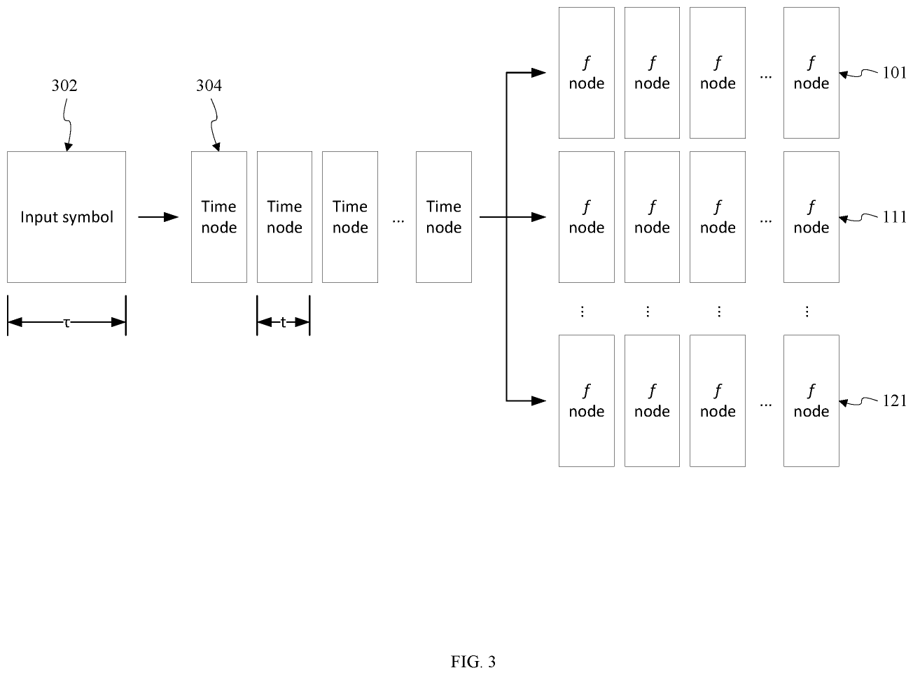

With reference to FIG. 3, the input symbol 302 is time masked to create a number of time nodes 304. The time nodes 304 are represented by index, i, when describing the state tensor X̅=[Xᵢⱼ]. For example, if the input symbol 302 is multiplexed by a time mask with a time scale of

$$δ t = \frac{τ}{50}$$

(i.e., each input symbol 302 is sampled 50 times) then 50 time nodes 304 will be created on each frequency channel 101, 111, 121 (i.e., i =1, 2, . . . , 50). The frequency channels are distinguished by the index j. As opposed to a conventional delay feedback reservoir in which only the time index, i, exists, the RC reservoir of embodiments have both time and frequency degrees of freedom. Embodiments allow for the selective coupling between different frequency channels which serve as another degree of freedom to enrich dynamics of the system. As used herein, “time node” may refer to the time nodes 304 that have been time multiplexed by the time mask. “Time-frequency node” or more simply, “frequency node” 101, 111, and 121, may refer to time nodes that have been combined using WDM 104 so that the nodes may be distinguished both in time and by frequency.

RCs with multicolor (multi-frequency) reservoirs offer high computational power by combining both time nodes and frequency nodes. If N is the number of time nodes created by a time mask and M is the number of incorporated frequency channels respectively, N×M nodes will be created. This enhances the computational power of the network with respect to a single frequency channel reservoir. The tunable coupling network provides an additional degree of freedom to adjust the network according to the nonlinear task being executed.

Embodiments allow for the reduction in the required number of time nodes that allows for slower time multiplexing at the input stage and for reading outputs. This can overcome the electrical bottlenecks outlined above. For example, if 50 time nodes 304 are generated with a time mask and three frequency channels are used there are 150 virtual nodes in total. Compared to an RC with 150 time nodes and only a single frequency channel, electrical and electronic components can operate at one third of the speed since the electrical bottleneck is dependent on the number of time nodes.

Embodiments may implement coupling network 116 in the optical domain or via external electronics, or a combination of optics and electronics. Generally, coupling network 116 acts as a matrix multiplier with respect to the frequency index and allows for coupling between frequencies. Matrix multiplication can be effectively carried out in the optical domain based on the topologies of cascaded integrated modulators.

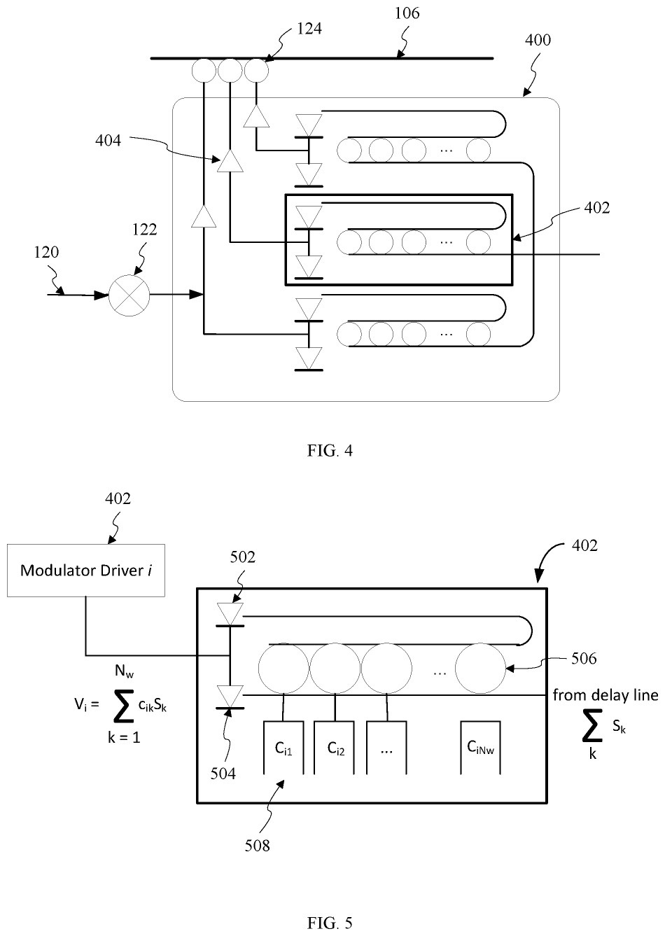

With reference to FIG. 4 and FIG. 5, embodiments may avoid extra stages of optical to electrical or electrical to optical signal conversions (illustrated in FIG. 1) by merging or combining the demultiplexing module (DEMUX) 110, for example a frequency demultiplexing module, and coupling network 116. The merging of demultiplexing module (DEMUX) 110 and coupling network 116 can be implemented using a variety of means including using ring weight topologies, using a balanced photodetector scheme, using cascaded ring modulators, or a combination thereof. FIG. 4 shows microring resonations 124, driven by modulator driver 404, modulating the WDM optical signal 106. After propagating through the delay line, the WDM signal is input into the combined DEMUX and coupling network 400. With reference to FIG. 5, DEMUX and coupling network 400 includes a set of cascaded ring modulators 506 and a balanced photodetector pair 502 and 504, for each optical frequency in the WDM signal. Each ring modulator is controlled by a coupling value 508. Embodiments utilizing coupling networks such as this may be used to implement a multicolor RC suitable for on-chip integration. Optical coupling networks may be integrated on an integrated circuit, eliminating the need for complicated electronic circuits. Also, the merging of DEMUX 110 and coupling network 116 into a combined DEMUX and coupling network 400 results in a more power efficient platform.

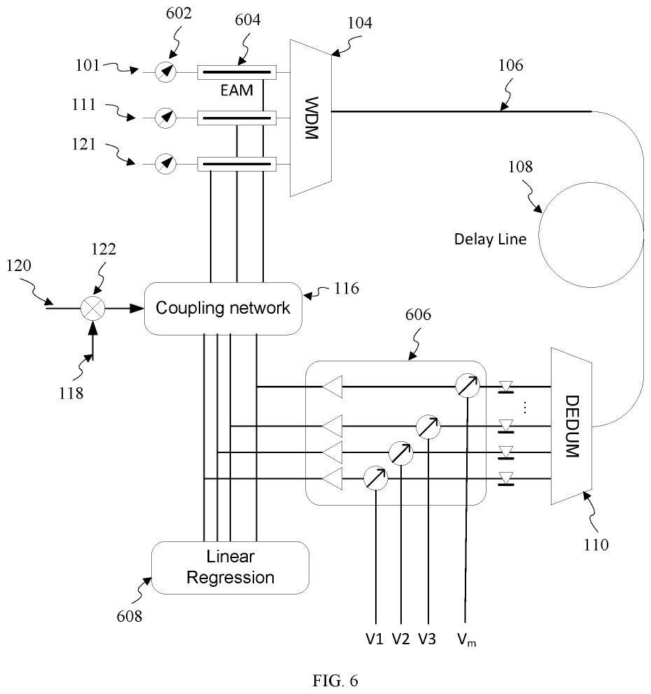

Embodiments may utilize a variety of modulators such as microring resonators 124, Mach-Zehnder modulators (MZM), electro-absorption modulator (EAM)s, integrated ring modulators, hybrid platforms, and combinations of different modulators and filters. FIG. 6 illustrates an RC that utilizes EAMs 604 to modulate the frequency nodes 101, 111, and 121. The dynamical behavior of the RC depends on the nonlinear transformation mediated by the modulators at each frequency channel, however various types of modulators may serve the RC. Some modulators allow for the full integration of RCs on silicon chips. The choice of modulator and their maximum modulation speed can place a limit on the maximum bandwidth of the frequency channels, therefore, it can be beneficial to take advantage of broadband modulators. Integrated modulators might have limited tunability which may make them non-ideal when compared to non-integrated components.

DC modulator profile compensators may be applied at the readout stage to remove baseline that may be associated with imperfect modulation profiles. The choice of modulator may present a tradeoff between high bandwidth, low power consumption, miniaturized footprint, and ease of integration. This provides flexibility in customizing an RC to handle non-ideal nonlinear transformations. The RC of FIG. 6 receives frequency nodes 101, 111, and 121 which are input to filters 602. Following that the filtered frequency nodes are modulated by EAMs 604. Other embodiments may use other types of appropriate modulators in place of EAMs 604. The RC of FIG. 6 also includes a modulator profile compensator 606 that includes voltage adders driven by voltages V1, V2, V3, . . . , Vₘ, followed by amplifiers. The outputs of modulator profile compensator 606, used as inputs to coupling network 116, may also be used as inputs to a linear regression module block 608. Linear regression block 608 is a specific type of readout 126 and training block. Outputs of linear regression block 608 are signals that will be linearly trained based on linear regression methods.

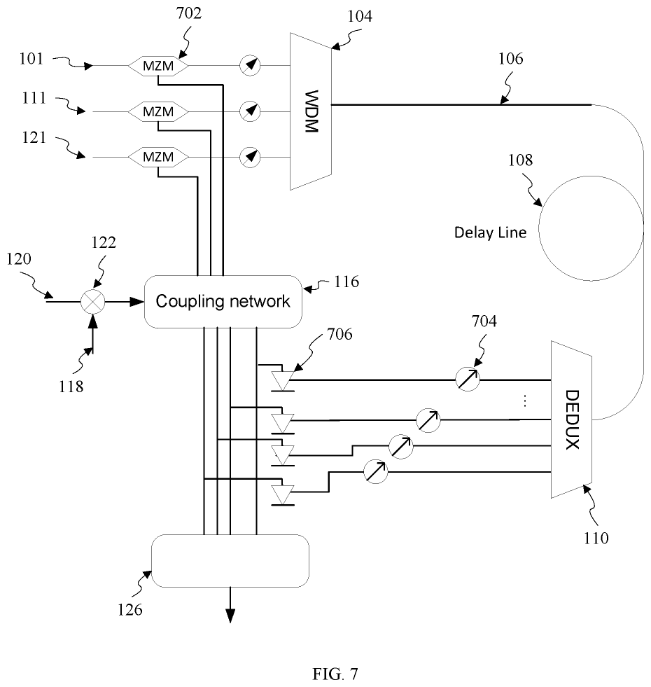

FIG. 7 illustrates an embodiment of an RC utilizing Mach-Zehnder modulators (MZM) 702 to modulate frequency nodes 101, 111, 121 before filtering the output of the MZMs 702 and inputting the filtered frequency nodes into WDM 104. After delay line 108, the WDM signal is filtered by filters 704 before being converted to electrical signals by detectors 706.

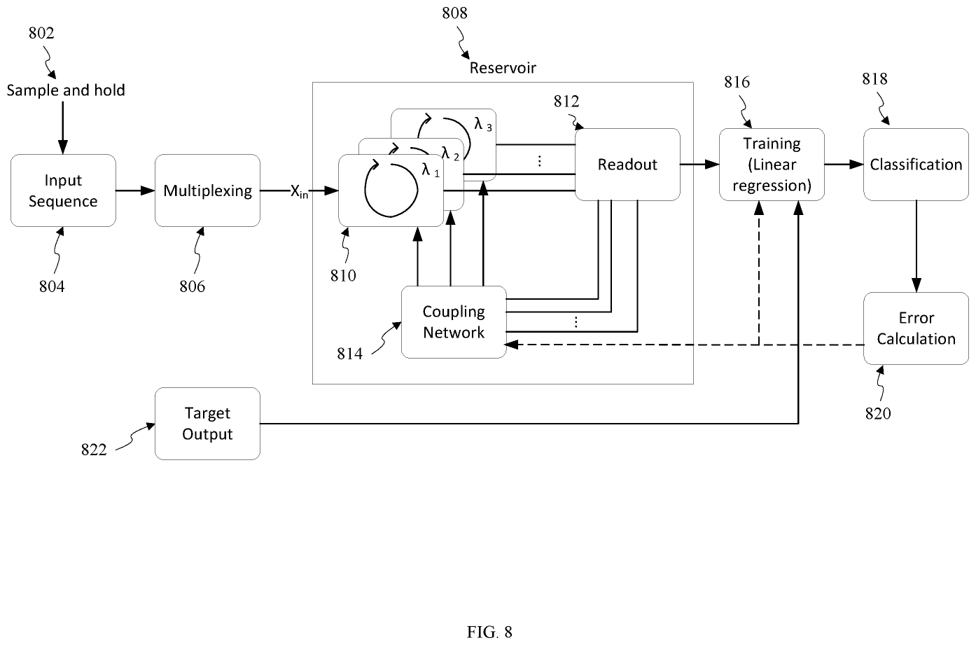

FIG. 8 illustrates an embodiment of an RC including steps taken when operating the RC. The reservoir 808 takes advantage of several frequency channels labelled λ₁, λ₂, and λ₃. The frequency channels are coupled at the readout stage 812. Operation starts when input sequence 804, obtained from “sample and hold” block 802, undergoes a time multiplexing stage 806 which involves multiplying the input data by a periodic time mask where the period of the time mask is significantly faster than the input data rate, for example ten times as fast. The time multiplexed data, Xᵢₙ, is mounted on multiple wavelength channels (rings) 810 through frequency multiplexing. Therefore, each time nodes in Xᵢₙ which have time indices, acquires frequency indices as well. The time multiplexed signal is injected into the reservoir 808 via a linear coupling circuit to drive the modulators associated with each of the channels 810. The multiplexed input, Xᵢₙ, is then circulated in various frequency channels 810. The nonlinear node at each frequency channel 810 includes a photodetector and a modulator in readout stages 812. Inputs to and parameters of coupling network 814 are adjusted depending on the task to be completed. Signals at the readout stages 812 are processed in parallel with each frequency having a readout layer. The output of the channels are trained 816 using linear regression methods and classification 818 as a whole for a specific task and target output 822. An error calculation 820 may be computed to form a feedback loop to adjust coupling network 814. Signals processed by the RC are received from readout 812, and will be sent to a computer for training which means where coefficients may be adjusted to map the output of the reservoir to the targeted signal. For example, for a speech recognition application, the output of the RC is trained to classify the data in classification block 818. The process will have some error and imperfections. To correct these errors and imperfections, the reservoir will be adjusted based on the errors detected. Coupling network 814 may be adjusted based on the error calculated 820 in the classification stage 818.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed by the computer.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using a combination of hardware and software and a necessary universal hardware platform. Based on such understandings, the technical solution of the present invention may include a software portion. The software portion may be stored in a non-volatile or non-transitory storage medium, which can be a compact disk read-only memory (CD-ROM), USB flash disk, or a removable hard disk. The software portion includes a number of instructions that enable a computer device (personal computer, server, or network device) to execute the methods provided in the embodiments of the present invention. For example, such an execution may correspond to a simulation of the logical operations as described herein. The software portion may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. A method for operating a reservoir computer, the method comprising:
receiving an input symbol;
applying a time mask to the input symbol to produce a plurality of time multiplexed time nodes;
modulating, using the plurality of time nodes, a plurality of frequency channels to produce a plurality of frequency nodes;
multiplexing the plurality of frequency nodes to produce a plurality of multiplexed frequency nodes;
coupling the multiplexed frequency nodes into a reservoir, the reservoir including a non-linear element;
receiving a delayed plurality of multiplexed frequency nodes from the reservoir;
demultiplexing the delayed plurality of multiplexed frequency nodes to produce a plurality of delayed time nodes;
modulating, using the plurality of delayed time nodes and the input time nodes, the plurality of frequency channels; and
outputting a response, the response based on the plurality of delayed time nodes.

2. The method of claim 1 wherein the plurality of frequency channels are modulated after being multiplexed to form the plurality of multiplexed frequency nodes.

3. The method of claim 1 wherein the plurality of frequency channels are modulated before being multiplexed to form the plurality of multiplexed frequency nodes.

4. The method of claim 1 wherein the plurality of delayed time nodes are input to a coupling network, the coupling network outputting a plurality of modulator driving signals.

5. The method of claim 1 wherein the plurality of modulator driving signals are outputs of electronic circuits.

6. The method of claim 1 wherein the plurality of modulator driving signals are outputs of optical circuits.

7. The method of claim 1 further comprising a modulator profile compensator to receive the plurality of delayed time nodes, the output of the modulator profile compensator being provided as inputs to the coupling network.

8. The method of claim 1 wherein a demultiplexing module and the coupling network are combined in an optical circuit.

9. The method of claim 1 wherein the plurality of modulator driving signals are based on the plurality of delayed time nodes and a masked data input, the masked data input being an input to the coupling network.

10. A reservoir computer comprising:
a frequency multiplexer portion receiving a plurality of virtual nodes of an input symbol, the frequency multiplexer portion outputting a modulated wavelength division multiplexing signal include the plurality of virtual nodes, the plurality of virtual nodes including a plurality of time nodes and a plurality of frequency nodes;
a modulator portion coupled to the frequency multiplexer portion for modulating the plurality of virtual nodes to produce a plurality of modulated frequency nodes;
a delay line coupled to the frequency multiplexer portion and the modulator portion, the delay line receiving the plurality of modulated frequency nodes and producing a plurality of delayed frequency nodes;
a demultiplexer portion receiving the plurality of delayed frequency nodes and producing a plurality of coupling matrix inputs, each of the plurality of inputs being derived from a demultiplexed one of the plurality of delayed frequency nodes; and
a coupling network coupled to the demultiplexer portion and the modulator portion, the coupling network receiving the coupling matrix inputs and producing a plurality of modulator driving signals.

11. The reservoir computer of claim 10 wherein the plurality of virtual nodes are modulated after being multiplexed to form the modulated wavelength division multiplexing signal.

12. The reservoir computer of claim 10 wherein the plurality of virtual nodes are modulated before being multiplexed to form the modulated wavelength division multiplexing signal.

13. The reservoir computer of claim 10 wherein the plurality of plurality of modulator driving signals are outputs of electronic circuits.

14. The reservoir computer of claim 10 wherein the plurality of modulator driving signals are outputs of optical circuits.

15. The reservoir computer of claim 10 further comprising a modulator profile compensator to receive the plurality of delayed frequency nodes, the outputs of the modulator profile compensator being provided as inputs to the coupling network.

16. The reservoir computer of claim 10 wherein a demultiplexing module and the coupling network are combined in an optical circuit.

17. The reservoir computer of claim 10 wherein the delay line includes a non-linear element.

18. The reservoir computer of claim 10 further comprising an output stage outputting a response based on the delayed plurality of delayed frequency nodes.

19. The reservoir computer of claim 10 wherein the coupling network further receives a masked data input, the plurality of modulator driving signals being based on both the coupling matrix inputs and the masked data input.
